(19) United States
(12) Patent Application Publication
(10) Pub. No.: US 2016/0156839 A1
(43) Pub. Date: Jun. 2, 2016

(54) POSITION DETECTION DEVICE

(71) Applicant: SHARP KABUSHIKI KAISHA, Osaka-shi, Osaka (JP)

(72) Inventor: Tomoya SHIMURA, Osaka-shi, Osaka (JP)

(73) Assignee: SHARP KABUSHIKI KAISHA, Osaka-shi, Osaka (JP)

(21) Appl. No.: 14/901,678

(22) PCT Filed: Jun. 11, 2014
(86) PCT No.: PCT/JP2014/065442

§ 371 Date: Dec. 28, 2015

(30) Foreign Application Priority Data
Jun. 28, 2013 (JP) 2013-137514

(51) Int. Cl. H04N 5/232; G06T 7/00; H04N 7/18; G06K 9/00; H04N 5/247

(52) U.S. Cl. CPC H04N 5/23219; G06K 9/00771; H04N 5/247; H04N 7/181; G06T 7/004

(57) ABSTRACT

A position detection device, provided with: an associating unit that uses a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, as a basis for associating a subject included in the first image and a subject included in the second image as the same subject; and a detection unit that detects three-dimensional coordinates of the associated subjects.

### TECHNICAL FIELD

The present invention relates to a position detection device. The present application claims priority on the basis of Japanese Patent Application No. 2013-137514 filed in Japan on Jun. 28, 2013, the contents of which are cited herein.

### BACKGROUND ART

Systems and techniques in which various sensors are used to recognize actions of people have been proposed in recent years, such as managing a person room occupation state in a room and entering and exiting from a room, detecting a suspicious person or an intruder, and monitoring a specific person remotely.

As a method for detecting a suspicious person, an intruder, or the like, there is a method in which a person or an object is tracked using two-dimensional processing on one camera image. Furthermore, there is also a technique for improving the position information of a detection target and the detection precision of a movement locus by the tracking of a person or an object being three-dimensionally processed from a stereo camera image. For example, PTL 1 proposes a suspicious person detection system in which two-dimensional processing and three-dimensional processing are combined to detect the position information, movement locus, and the like of a suspicious person or the like with greater precision (see PTL 1).

### CITATION LIST

### Patent Document

[PATENT DOCUMENT 1] Japanese Unexamined Patent Application Publication No. 2012-79340

### DISCLOSURE OF THE INVENTION

### Problems to be Solved by the Invention

However, the suspicious person detection system described in PTL 1 has a problem in that although imaging by a plurality of cameras is performed, the installation positions of the cameras have to be precisely adjusted, and installation is difficult by anyone other than a person having the special skills required for such an adjustment.

Thus, the present invention takes the problem of the conventional technology into consideration, and an objective thereof is to provide a position detection device with which it becomes easy for the installation of a camera that acquires an image for detecting the position of a subject to be performed by a user.

### Means for Solving the Problems

This invention has been devised in order to solve the aforementioned problem, and one aspect of the present invention is a position detection device, provided with: an associating unit that uses a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, as a basis for associating a subject included in the first image and a subject included in the second image as the same subject; and a detection unit that detects three-dimensional coordinates of the associated subjects.

### Effects of the Invention

According to the present invention, it is possible to provide a position detection device with which it becomes easy for the installation of a camera that acquires an image for detecting the position of a subject to be performed by a user.

### BRIEF DESCRIPTION OF THE DRAWINGS

FIG. 1 is an exemplary external view depicting a usage situation of a position detection device in a first embodiment.

FIG. 2 is an example of a first image and a second image in the first embodiment.

FIG. 3 is an exemplary block diagram depicting a configuration of the position detection device in the first embodiment.

FIG. 4 is an exemplary flowchart of an operation of the position detection device in the first embodiment.

FIG. 5 is an exemplary parallel projection diagram in which a room interior rm in the first embodiment is seen from the ceiling.

FIG. 6 is an example of a first image in a modified example of the first embodiment.

FIG. 7 is an example of a second image in the modified example of the first embodiment.

FIG. 8 is an external view depicting a usage situation of a position detection device in a second embodiment.

FIG. 9 is a block diagram depicting a configuration of the position detection device in the second embodiment.

FIG. 10 is an exemplary external view depicting a usage situation of a position detection device in a third embodiment.

FIG. 11 is an example of a drawing for describing a non-capturable region in the third embodiment.

FIG. 12 is an example of a drawing for describing a condition with which the non-capturable region uns in the third embodiment is not produced.

### MODE FOR CARRYING OUT THE INVENTION

### First Embodiment

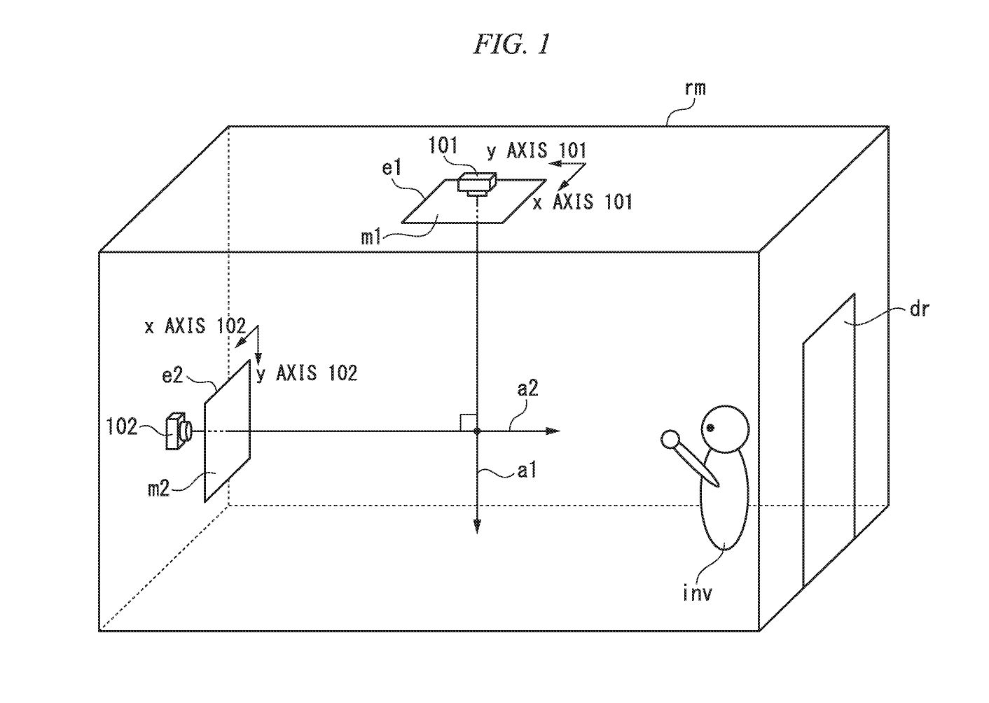

Hereinafter, a first embodiment will be described with reference to the drawings. FIG. 1 is an external view depicting an example of a usage situation of a position detection device 2 in the first embodiment. A first camera 101 and a second camera 102 are connected to the position detection device 2. The position detection device 2 in the present embodiment detects the three-dimensional position of a subject by associating the positions of the subject displayed in planar images captured by those two cameras.

A person inv who has entered from a door dr is present in a room interior rm. The first camera 101 is installed on the ceiling in the room interior rm. The first camera 101 captures the room interior rm in a vertically downward direction from the ceiling. Consequently, the first camera 101 performs imaging from above the head of the person inv. The second camera 102 is installed on a wall on the opposite side to the door in the room interior rm. The second camera 102 captures the room interior rm in a horizontal direction from the wall surface. Consequently, the second camera 102 captures the entire body of the person inv from the side.

It should be noted that although the second camera 102 is installed on the opposite wall of the room interior rm to the door dr, the present invention is not restricted thereto, and the second camera 102 may be installed on the left or right wall surface as seen from the door dr, or may be installed on the wall in which the door dr is installed. However, it is desirable that the second camera 102 be installed on the opposite wall to the door dr since it is easier when installed on the opposite surface to the door dr for the face of the person inv, who is a person who has entered the room, to be captured compared to when installed on another wall surface.

The first camera 101 and the second camera 102, for example, are cameras provided with a charge-coupled device (CCD) element, a complementary metal oxide semiconductor (CMOS) imaging element, or the like, which are imaging elements that convert concentrated light into an electrical signal. The first camera 101 and the second camera 102, for example, are connected by a High-Definition Multimedia Interface (HDMI) (registered trademark) cable or the like to the position detection device 2, which is omitted from FIG. 1 as the drawing would become complex. The position detection device 2, for example, may be installed in the room interior or may be installed in another room. In the present embodiment, the position detection device 2 is installed in another room. In the following description, an image captured by the first camera 101 is referred to as a first image, and an image captured by the second camera 102 is referred to as a second image. The first image and the second image are two-dimensional images.

The position detection device 2 acquires a first image from the first camera 101 and acquires a second image from the second camera 102. The position detection device 2 detects the face of the person inv from the acquired first image. Furthermore, the position detection device 2 detects the face of the person inv from the acquired second image. The position detection device 2 associates the face detected from the first image and the face detected from the second image (hereinafter, referred to as face association processing), and detects three-dimensional position coordinates of the face of the person inv.

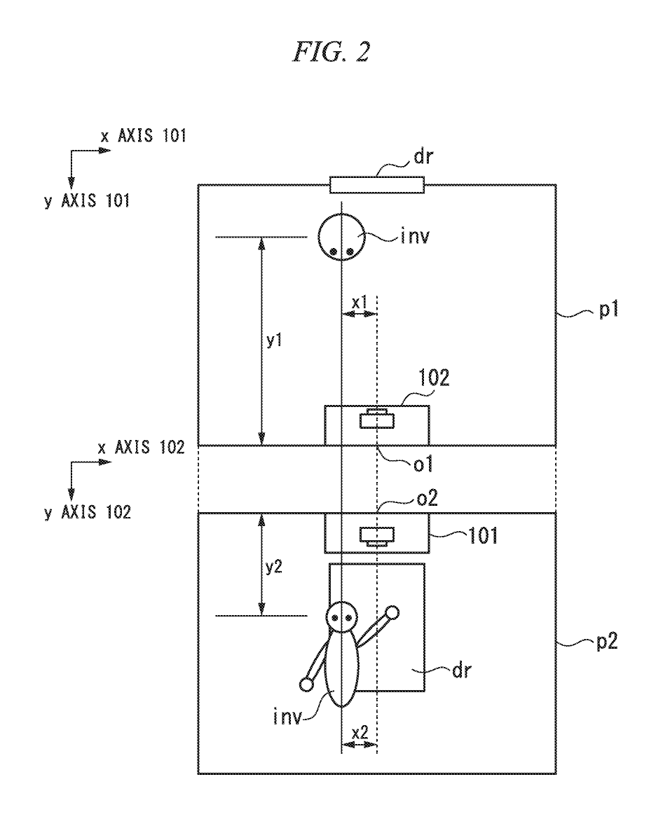

Here, details of the face association processing will be described with reference to FIG. 2. FIG. 2 is an image diagram depicting an example of a first image p1 and a second image p2. The upper section of FIG. 2 is the first image p1 and the lower section is the second image p2. The first camera 101 captures the face of the person inv from above the head as the first image p1 and, in addition, captures the second camera 102 in the center of the lower section of the first image p1. The second camera 102 captures the entire body of the person inv as the second image p2 and, in addition, captures the first camera 101 in the center of the upper section of the second image p2. As depicted in FIG. 2, due to installation being carried out such that each camera is displayed in the center of the image captured by the other camera, the optical axes of both cameras invariably intersect. The intersecting of the optical axes will be described later on.

The first camera 101 is installed such that the subject is captured as an image that is approximately parallel-projected. Furthermore, the second camera 102 is installed such that the subject is captured as an image that is approximately parallel-projected. When approximately parallel-projected, in the case where images in which the distance between the camera and the subject has been changed are to be compared, there is hardly any change in the position coordinates of the subject in the images. This property is used for the position detection device 2 of the present embodiment to detect the three-dimensional position of the person inv. Consequently, in the following description, images captured by the first camera 101 and the second camera 102 are assumed to be images that are approximately parallel-projected.

In the first image p1, the distance from the optical axis of the first camera 101 to the face of the person inv is taken as a distance x1. Furthermore, in the second image p2, the distance from the optical axis of the second camera 102 to the face of the person inv is taken as a distance x2. When origins o1 and o2 are set in each image as depicted in FIG. 2, the coordinates of the face of the person inv in the first image are (x1, y1), and the coordinates of the face of the person inv in the second image are (x2, y2). Here, if the person inv displayed in the first image p1 and the person inv displayed in the second image p2 are the same person, the coordinate x1 and the coordinate x2 match as depicted in FIG. 2. This match occurs because the first image p1 and the second image p2 are images in which the subject is approximately parallel-projected.

However, the coordinate x1 and the coordinate x2 simply match only in the case where, when the same target object is captured by each camera, that target object is depicted with the same number of pixels within the two images. If, when the same target object is captured, that target object is depicted with different numbers of pixels within the two images, it is necessary to perform a correction corresponding to that difference in the pixel numbers. In the following description, a description is given in which there is no such difference in the pixel numbers (for example, the two cameras are the same camera) in order to simplify the description. When the matching coordinate x1 and coordinate x2 are taken as three-dimensional x coordinates of the person inv (x1=x2=x), the coordinate y1 becomes a three-dimensional y coordinate and the coordinate y2 becomes a three-dimensional z coordinate. In this way, in the case of an image in which the subject is approximately parallel-projected, three-dimensional position coordinates of the person inv can be acquired by associating the x coordinates of the person inv displayed in the first image p1 and the second image p2.

Returning to FIG. 1, the first camera 101 and the second camera 102 have to be installed such that prescribed conditions are satisfied in order for the face association processing to be performed. The prescribed conditions in the present embodiment are the following installation conditions (1a) and (1b). Installation condition (1a), for example, is that the optical axes of both cameras intersect as depicted in FIG. 1. Installation condition (1b) is that the sides of the projection plane of one camera and the projection plane of the other camera that are closest to each other be substantially parallel. It should be noted that the installation condition (1b) may be rephrased as the sides of the imaging element of one camera and the imaging element of the other camera that are closest to each other being substantially parallel. A projection plane m1 of the first camera 101 and a projection plane m2 of the second camera 102 are depicted in FIG. 1. When the two cameras are installed such that the installation condition (1b) is satisfied, the side e1 that is closest to the projection plane m2 from among the sides of the projection plane m1 and the side e2 that is closest to the projection plane m1 from among the sides of the projection plane m2 should be substantially parallel. By performing installation such that the installation conditions (1a) and (1b) are satisfied, if the persons inv displayed in the first image and the second image are the same person, the distance x1 and the distance x2 match as depicted in FIG. 2.

When the cameras are installed such that the installation conditions (1a) and (1b) are satisfied, in the first image and the second image, for example, the casings of both cameras are displayed in the central region of any of the upper section, the lower section, the left section, or the right section of the projection plane of the other camera as depicted in FIG. 2. A simple method for realizing this situation is, for example, a method in which a pattern such as a specific geometric pattern or the like is irradiated from one camera for that pattern to be captured by the other camera, and the orientations of the cameras are adjusted while looking at the image captured by the other camera. Specifically, that pattern is a rectangular grid pattern or the like made of a repeating pattern of black and white squares. First, the first camera 101 captures, from the ceiling, a grid pattern that is irradiated such that a rectangle is maintained from the ceiling toward the floor surface (so as to not become a trapezoid) and one side of the grid pattern becomes parallel with the wall surface on which the second camera 102 is installed. A user (for example, the person who installed the cameras) adjusts the orientation of the first camera 101 while confirming that the captured grid pattern is not being displayed as a trapezoid. For example, when the longitudinal direction of the first camera 101 is taken as the x axis and the lateral direction is taken as the y axis, the user performs an adjustment such that the grid pattern is captured as a rectangle by first performing rotation around the x axis and the y axis, and then performs an adjustment such that the second camera 102 is captured in the center of the lower section of the projection plane by performing rotation around an optical axis a1 (z axis). By carrying out installation in this way, the optical axis a1 of the first camera 101 assumes a vertically downward orientation. Furthermore, one side of the projection plane of the first camera 101 becomes parallel with the wall surface on which the second camera 102 is installed.

Next, the user captures the grid pattern captured by the first camera 101, with the second camera 102 from the wall surface. The grid pattern captured by the second camera 102 is displayed as a trapezoid. The user adjusts the orientation of the second camera 102 such that the left and right deformations of the grid pattern captured as a trapezoid become substantially the same (substantially the same left and right heights). The user captures, with the second camera 102, the grid pattern irradiated such that a rectangle is maintained toward the wall surface on the opposite side to the wall surface on which the second camera 102 is installed. At such time, for example, when the longitudinal direction of the second camera 102 is taken as the x axis and the lateral direction is taken as the y axis, the user performs rotation around the x axis and the y axis to thereby make the left and right deformations substantially the same. Thereafter, the user performs rotation around an optical axis a2 of the second camera 102, and thereby performs an adjustment such that the first camera 101 is captured in the center of the upper section of the projection plane. By performing installation in this way, a situation is realized in which the casings of both cameras are displayed in the central region of any of the upper section, the lower section, the left section, or the right section of the projection plane of the other camera. As a result, one side of the projection plane of the second camera 102 becomes parallel with the floor surface. Furthermore, the sides of the projection plane of the first camera 101 and the projection plane of the second camera 102 that are closest to each other become substantially parallel. In addition, the optical axis a1 of the first camera 101 and the optical axis a2 of the second camera 102 intersect. Consequently, the first camera 101 and the second camera 102 are installed such that the installation conditions (1a) and (1b) are satisfied. In the present embodiment, the optical axis a1 and the optical axis a2 are orthogonal in order to simplify the description; however, it should be noted that the present invention is not restricted thereto.

The grid pattern that is irradiated is a rectangle in the present embodiment; however, it should be noted that the present invention is by no means restricted thereto. The grid pattern that is irradiated, for example, may be a trapezoid and may be irradiated on the floor surface or a wall surface at an angle inclined by an angle θ from the optical axis of the camera such that the irradiated grid pattern is displayed as a rectangle. Furthermore, although the shape of the grid pattern is affected by recesses and protrusions of the floor surface or the wall surface onto which the grid pattern is irradiated, there are no particular problems as long as the shape of the grid pattern is substantially rectangular.

Hereinafter, a configuration and operation of the position detection device 2 will be described on the assumption that the first camera 101 and the second camera 102 are installed such that the installation conditions (1a) and (1b) are satisfied.

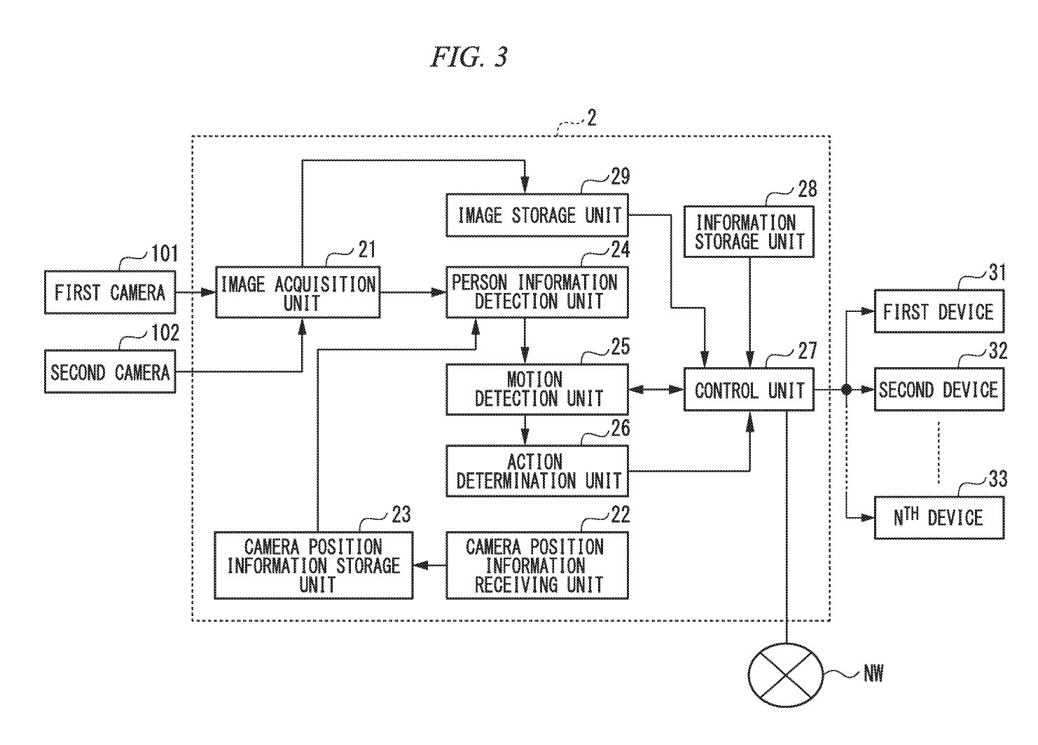

FIG. 3 is a schematic block diagram depicting a configuration of the position detection device 2 in the first embodiment. The position detection device 2, for example, includes an image acquisition unit 21, a camera position information receiving unit 22, a camera position information storage unit 23, a person information detection unit 24, a motion detection unit 25, an action determination unit 26, a control unit 27, and an information storage unit 28. Furthermore, the position detection device 2 is communicably connected to a first device 31 to an n^{th} device 3n by a local area network (LAN) or the like. Hereinafter, the first device 31 to the n^{th} device 3n are collectively referred to as a device 1.

The image acquisition unit 21, for example, acquires images from the first camera 101 and the second camera 102 connected to the image acquisition unit 21. The image acquisition unit 21 acquires a first image from the first camera 101 and acquires a second image from the second camera 102, but is not restricted thereto, and may acquire images also from a third camera, a fourth camera, and the like which are connected. The image acquisition unit 21 outputs the first image and the second image, which are associated with a camera ID of the camera that performed the imaging and an imaging time, to the person information detection unit 24 in order of the imaging time. Furthermore, the image acquisition unit 21 causes the first image and the second image associated with the camera ID of the camera that performed the imaging and the imaging time, to be stored in an image storage unit 29 in order of the imaging time. The image storage unit 29, for example, is a storage medium such as a hard disk drive (HDD) or a solid state drive (SSD).

The camera position information receiving unit 22 receives camera position information in accordance with an input operation from the user, and causes the received camera position information to be stored in the camera position information storage unit 23. The camera position information, for example, is information obtained by associating a camera ID that identifies a camera connected to the position detection device 2 and information that indicates the distance from the camera indicated by the camera ID to a point at which imaging is desired to be performed (hereinafter, referred to as the imaging distance). In the case where there is a difference in the pixel numbers as previously mentioned, the camera position information is information that is used to correct that difference. The camera position information storage unit 23 is a temporary storage medium such as a random access memory (RAM) or a register.

The person information detection unit 24 acquires the first image and the second image from the image acquisition unit 21. Thereafter, the person information detection unit 24 acquires the camera position information from the camera position information storage unit 23. The person information detection unit 24, for example, detects a region depicting the face of a person (hereinafter, referred to as a face region) from each of the first image and the second image acquired in order of imaging time. In the present embodiment, the face region is detected from each of the first image and the second image as pixels having a color signal value included within a preset range of color signal values that indicate the color of the face of a person. The color region, for example, may be detected by calculating a Haar-Like feature quantity from each of the first image and the second image, and performing predetermined processing such as an Adaboost algorithm on the basis of the calculated Haar-Like feature quantity.

Here, in the case where a face region has been detected from both the first image and the second image, the person information detection unit 24 extracts representative points of the face regions detected from each of the first image and the second image, and detects the two-dimensional coordinates of the extracted representative points. A representative point is the center of gravity, for example. Hereinafter, the two-dimensional coordinates of the representative point of the face region obtained from the first image are referred to as first two-dimensional coordinates. Furthermore, the two-dimensional coordinates of the representative point of the face region obtained from the second image are referred to as second two-dimensional coordinates.

The person information detection unit 24 performs face association processing on the basis of the detected first two-dimensional coordinates and the second two-dimensional coordinates, associates the person displayed in the first image and the second image, and calculates three-dimensional position coordinates of that person. At such time, if necessary, the person information detection unit 24 uses the camera position information to calculate the three-dimensional position coordinates. Furthermore, in the case where a face region has been able to be detected from only one of either of the first image and the second image, or in the case a face region has not been able to be detected from either of the first image and the second image, information indicating that a person has not been detected is output to the motion detection unit 25 as person information. It should be noted that the person information detection unit 24 may detect two-dimensional face region information or the like indicating two-dimensional coordinates of the upper edge, the lower edge, the left edge, or the right edge of the face region instead of detecting the two-dimensional coordinates of a representative point.

When the three-dimensional position coordinates are calculated, the person information detection unit 24 outputs a person ID that identifies the person associated with the calculated three-dimensional position coordinates, and information indicating the face of the person corresponding to the person ID, to the motion detection unit 25 as person information. Furthermore, the person information detection unit 24 outputs the first image corresponding to the person information to the motion detection unit 25 together with the person information.

The motion detection unit 25 acquires the person information and the first image corresponding to the person information. The motion detection unit 25, for example, retains a plurality of frame images having different imaging times, detects a luminance change between the current first image and the immediately preceding first image, and thereby detects a region in which the luminance change has exceeded a prescribed threshold value (a) as a region in which movement has occurred (hereinafter, referred to as a movement region). A luminance change is used to detect a movement region in the present embodiment; however, it should be noted that the present invention is not restricted thereto, and the face of a person may be detected from the first image as with the person information detection unit 24, and a movement region may be detected on the basis of the detected face and a plurality of frame images having different imaging times. However, since the first image is an image that has been captured from the ceiling toward the floor surface, it is not always possible for a face to be detected, and therefore a method using luminance changes is preferred for detecting the same region.

The motion detection unit 25 detects movement region coordinates, which are coordinates indicating the position of the center of gravity of a detected movement region. The motion detection unit 25 calculates the amount of movement of the center of gravity of the movement region on the basis of the detected movement region coordinates of each imaging time. The amount of movement, for example, is the distance moved or the like. When calculating the amount of movement, the motion detection unit 25 generates, as tracking information, a movement vector that indicates the amount of movement calculated, the coordinates of each imaging time, the direction of movement of each imaging time, and the like. The motion detection unit 25 compares the coordinates of each imaging time of the tracking information and the x coordinates and the y coordinates of the three-dimensional position coordinates of the person information, and associates the tracking information and the person ID. Thereafter, the motion detection unit 25 outputs the person information and the tracking information to the action determination unit 26 and the control unit 27. It should be noted that in the case where a movement region has not been detected, the motion detection unit 25 outputs information indicating that tracking is not possible, as tracking information to the control unit 27.

The action determination unit 26 determines the action of a person who has entered the room (hereinafter, referred to as an action determination) on the basis of the acquired person information. Specifically, the action determination unit 26 determines a state in which a person indicated by the person ID associated with the three-dimensional position coordinates is standing, or a state in which the person is lying down, in accordance with whether or not the z coordinate of the three-dimensional position coordinates included in the person information has exceeded a prescribed threshold value (b). It should be noted that the action determination unit 26 may set two prescribed threshold values (b), determine that the person is bent over when a first prescribed threshold value (b) is exceeded, determine that the person is lying down when a second prescribed threshold value (c) is exceeded, and determine that the person has jumped when less than a third prescribed threshold value (d).

On the basis of the result of the action determination according to the person information and the acquired tracking information, the action determination unit 26 detects an action of the person that is common to both of the aforementioned. The action determination unit 26 detects a “fallen over” action in the case where a person who was stood up and moving suddenly lies down and does not move for a while, for example. The action determination unit 26 outputs the detected action to the control unit 27 as action information associated with the person ID. It should be noted that the action information is not restricted to a person having “fallen over”, and may be “a person who was lying down has stood up”, “moved while bending over (suspicious action)”, “jumped”, or the like.

The information storage unit 28 is a storage medium such as an HDD or an SSD. The information storage unit 28 stores registered person information and registered action information that has been registered in advance from the user. The registered person information, for example, is information for authenticating the face of a person permitted to enter into a room. The registered action information, for example, is information in which information indicating a prescribed action, a device connected to the position detection device 2, and information indicating an operation to be performed by the device are associated.

The control unit 27 acquires registered person information and registered action information from the information storage unit 28 when acquiring person information and tracking information from the motion detection unit 25 and acquiring action information from the action determination unit 26. The control unit 27, for example, compares the action information and the acquired registered action information to thereby determine whether or not the person detected in the room has performed a prescribed action. In the case where a person detected in the room has performed a prescribed action, the control unit 27 causes the device 1 associated with the prescribed action of the registered action information to execute a prescribed operation on the basis of the information indicating the operation to be performed by the device. In the case where, for example, the prescribed action is “jump”, the prescribed device is “a television receiver”, and the prescribed operation is “turn the power off”, the control unit 27 turns the power for a television receiver connected to the position detection device 2 to off when the person detected in the room has jumped. Furthermore, if necessary, the control unit 27 acquires a captured image from the image storage unit 29. The control unit 27, for example, causes the captured image to be output and displayed on the television receiver, a note personal computer (PC), a tablet PC, an electronic book reader equipped with network functionality, or the like.

It should be noted that the control unit 27, for example, may compare information indicating the face of the person associated with the person ID of the person information and the acquired registered person information to thereby determine whether or not the person captured by the first camera 101 and the second camera 102 is permitted to enter into the room in which imaging is being performed. In this case, if it is determined that the person being detected is a person who is not permitted to enter into the room, the control unit 27 causes a device that notifies a security company or the police from among the first device 31 to the n^{th} device 33 to perform notification. Furthermore, in the case where the tracking information is information indicating that tracking is not possible, the control unit 27 puts the motion detection unit 25 on standby, and causes the person information detection unit 24 to continue generating person information.

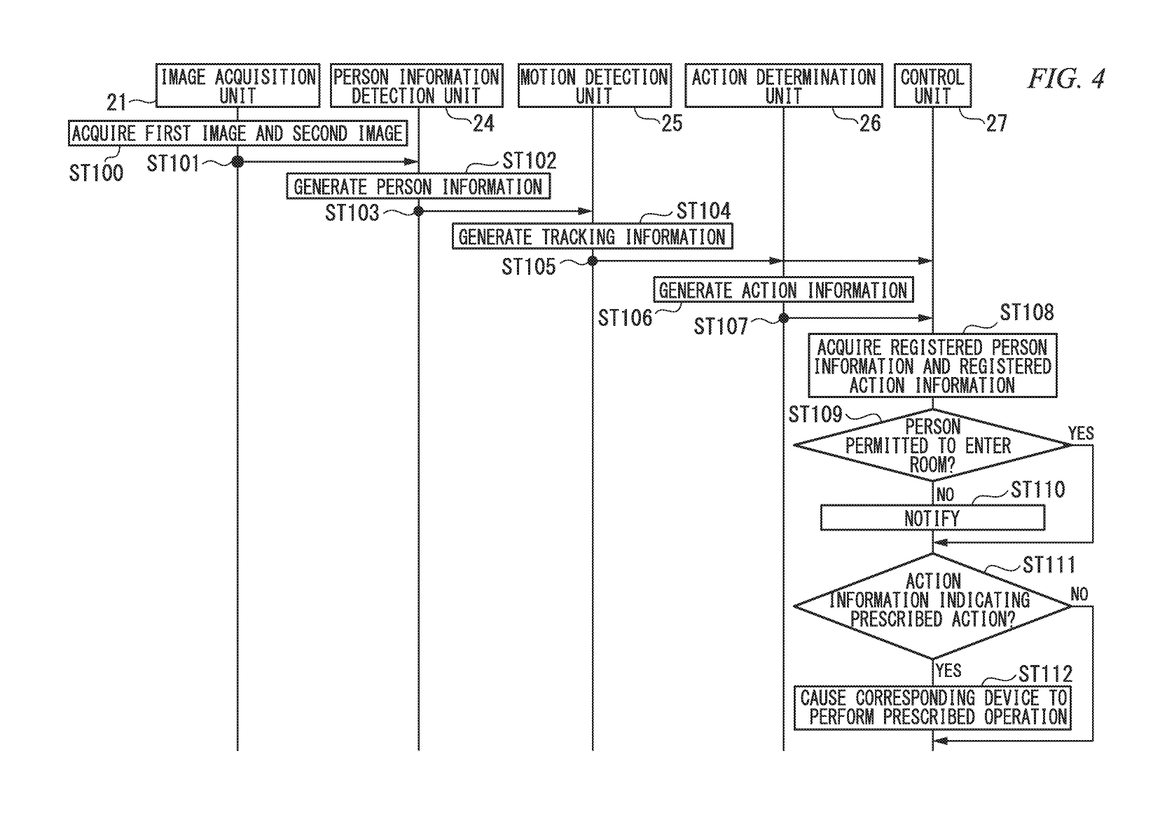

FIG. 4 is an example of a sequence diagram describing an operation of the position detection device 2. First, the image acquisition unit 21 acquires a first image and a second image (ST100). Next, the image acquisition unit 21 outputs the first image and the second image to the person information detection unit 24 (ST101). Next, the person information detection unit 24 generates person information on the basis of the first image and the second image (ST102). Next, the person information detection unit 24 outputs the person information to the motion detection unit 25 (ST103). Next, the motion detection unit 25 generates tracking information on the basis of the person information and the first image (ST104). Next, the motion detection unit 25 outputs the person information and the tracking information to the action determination unit 26 and the control unit 27 (ST105). Next, the action determination unit 26 generates action information on the basis of the person information and the tracking information (ST106). Next, the action determination unit 26 outputs the action information to the control unit 27 (ST107).

Next, the control unit 27 acquires registered person information and registered action information (ST108). Next, the control unit 27 determines whether or not the detected person is a person who is permitted to enter the room, on the basis of the registered person information and the person information (ST109). The control unit 27 transfers to ST110 when the person is not permitted to enter the room (ST109—no). The control unit 27 transfers to ST111 when the person is permitted to enter the room (ST109—yes).

In ST109, when the person is not permitted to enter the room, the control unit 27 performs notification by operating the device that notifies the security company or the police (ST110). In ST109, when the person is permitted to enter the room, the control unit 27 determines whether or not the action information indicates a prescribed action (ST111). When the action information has indicated a prescribed action (ST111—yes), the control unit 27 transfers to ST112. When the action information has not indicated a prescribed action (ST111—no), the control unit 27 terminates processing. When the action information has indicated a prescribed action in ST111, the control unit 27 executes a prescribed operation with respect to a corresponding device (ST112).

In this way, the position detection device 2 in the first embodiment can detect the three-dimensional position coordinates of a person that is approximately parallel-projected, from the first image and the second image, which are two-dimensional images, due to the first camera 101 and the second camera 102 being installed such that the installation conditions (1a) and (1b) are satisfied. Furthermore, the position detection device 2 generates tracking information indicating the way in which the person has moved, and generates action information indicating what kind of action has been performed by the person, on the basis of the person information and the tracking information.

On the basis of the action information, the position detection device 2 is able to comprehend the action of a person inside the room, and, in addition, is able to cause a prescribed device to execute an operation corresponding to the action information. Furthermore, these effects are able to be obtained by performing installation such that the installation conditions (1a) and (1b) are satisfied, and it is therefore possible for the first camera 101 and the second camera 102 to be installed in a simple manner even by a person who does not possess special skills. It should be noted that the person information detection unit 24 may detect the orientation and expression of the face of a person, and the action determination unit 26 may determine the action of the person in greater detail on the basis thereof.

### MODIFIED EXAMPLE OF FIRST EMBODIMENT

Hereinafter, a modified example of the first embodiment will be described. With regard to the configuration, FIGS. 1 and 3 are cited, and the same functional units are denoted by the same reference signs. In the modified example of the first embodiment, it is not necessary for the first camera 101 and the second camera 102 to be installed such that the subject is approximately parallel-projected.

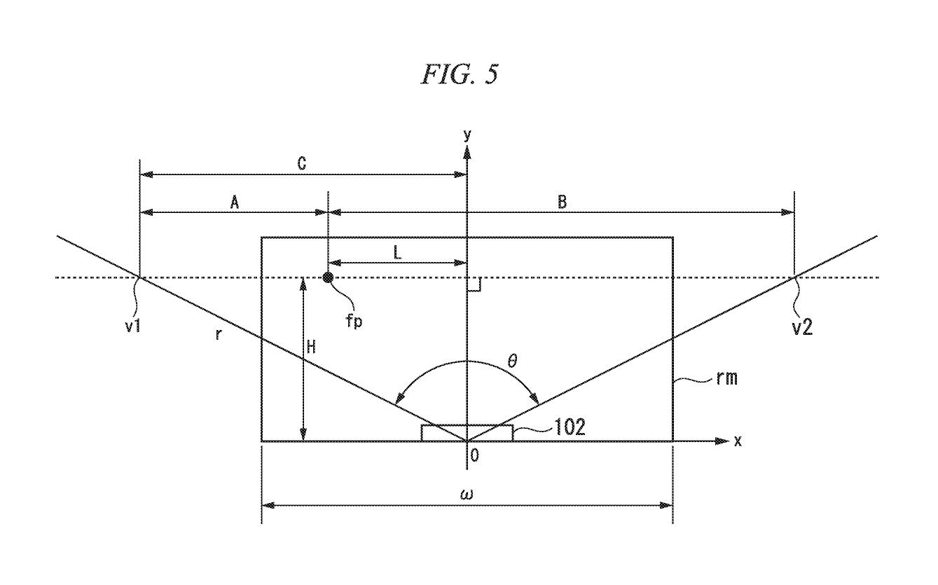

The person information detection unit 24 of the modified example of the first embodiment detects the coordinates of toes instead of detecting coordinates indicating the center of gravity of the face of the person inv, from the first image and the second image, and associates the person inv displayed in the first image and the person inv displayed in the second image, on the basis of the detected toe coordinates. Hereinafter, a method in which the person information detection unit 24 associates persons inv will be described with reference to FIGS. 5, 6, and 7.

FIG. 5 is a parallel projection diagram in which the room interior rm is seen from the ceiling. This drawing merely depicts a room interior in real three-dimensional space, and therefore is not an image captured by the first camera 101 or the second camera 102. A point fp is a point representing the toes of the person inv. The center of the second camera 102 is taken as an origin o, solid lines extending to each of an intersection v1 and an intersection v2 from the origin o indicate the range of the angle of view of the second camera 102, and the angle of view is taken as θ. A length A, a length B, a length C, and a length L in the drawing are defined in consideration of the dotted line passing through the intersection v1 and the intersection v2. Here, the length unit is meters, for example. The line portion joining the intersection v1 and the intersection v2 indicates a projection plane captured as the second image by the second camera 102. The length of the line portion o-v1 and the line portion o-v2 is taken as r, and the coordinates of the point fp are taken as (L, H). Furthermore, the width of the floor surface of the room interior rm is taken as ω.

Here, the person information detection unit 24 captures the situation depicted in FIG. 5 with the first camera 101 and the second camera 102, and associates the x coordinates of the points fp displayed in the first image in the second image, and is thereby able to associate that the point fp displayed in the first image and the point fp displayed in the second image are a point fp of the same person. Due to this association being performed, the person information detection unit 24 calculates the ratio between the length A and the length B on the basis of the coordinates acquired from the first image and the second image. The ratio between the length A and the length B indicates where the point fp is displayed in the x direction in the projection plane that indicates the second image. This is because the point fp on the projection plane is invariably displayed in a location having this ratio. Consequently, the ratio between the length A and the length B can be calculated, and, in addition, as long as the coordinates of the point fp in the first image can be detected, the point fp of the first image and the point fp of the second image can be associated on the basis of the calculated ratio between the lengths and the detected coordinates.

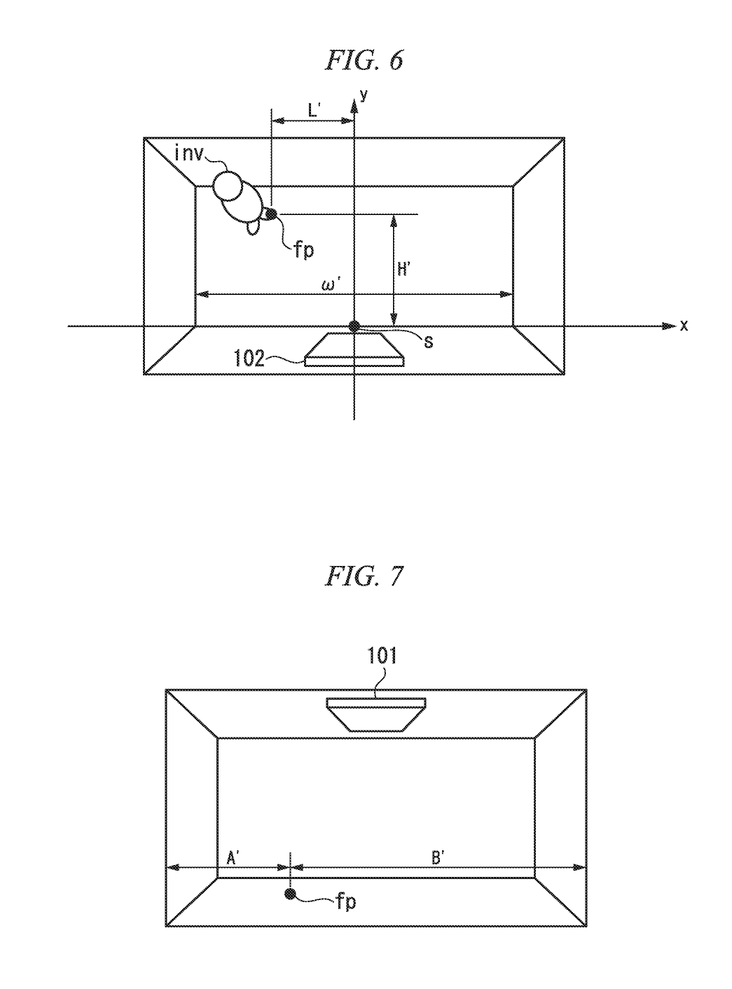

FIG. 6 is an example of a first image in which the room interior rm of FIG. 5 is captured by the first camera 101 in the modified example of the first embodiment. Different from the first image of the first embodiment, in the first image in the modified example of the first embodiment, the subject is perspective-projected. When the subject is perspective-projected, the coordinates in the image that do not change when parallel-projected (hereinafter, referred to as in-image coordinates) change in accordance with the angle of view of the camera in the case where the distance between the camera and the subject has changed (in the case where the person has stood or sat down). However, in the case where the in-image coordinates of the point fp indicating the toes of the person inv are to be detected, since the point fp does not separate from the floor surface to a great extent, changes in the distance between the camera and the subject can be ignored within a certain error range. A certain error range is plus/minus 10% of the in-image coordinates, for example.

Here, in the modified example of the first embodiment, for example, a mark s that is the origin of an in-image coordinate axis of the first image is set directly below the center of the second camera 102. The in-image coordinates of the point fp are indicated as (L′, H′) with the mark s as the origin. The width of the floor surface displayed in the first image is taken as ω′. It should be noted that the mark s may be recognized by the position detection device 2 only the first time, or may be set throughout imaging. The person information detection unit 24 calculates the in-image coordinates (L′, H′) and the width ω′. The person information detection unit 24 calculates the ratio between the length A and the length B as follows on the basis of the detected in-image coordinates (L′, H′) and the width ω′, the angle of view θ decided for each camera, and the actual width ω of the floor surface of the room interior rm corresponding to the width ω′. It should be noted that the angle of view θ and the width ω′ may be registered in advance by the user, and items registered by the user in a storage unit may be read. Furthermore, the units of the width ω′ and the in-image coordinates (L′, H′) are pixels, for example.

First, the person information detection unit 24 calculates the scale ratio between the actual world and in the images according to the ratio between the width w and the width ω′. The person information detection unit 24 multiplies the calculated scale ratio by each of the coordinate values of the in-image coordinates (L′, H′) of FIG. 6, and calculates the lengths L and H of FIG. 5 from the following expressions.

L=ω/ω′×L′ (1)

H=ω/ω′×H′ (2)

Next, the person information detection unit 24 calculates the length C depicted in FIG. 5 from the following expression on the basis of a trigonometric function with the angle of view θ and the length H.

C=H tan(θ/2) (3)

Next, the person information detection unit 24 calculates the lengths A and B from the following expression on the basis of the lengths C and L.

A=C−L (4)

B=C+L (5)

The person information detection unit 24 calculates the ratio between the lengths A and B calculated according to expressions (4) and (5). Based on the calculated ratio between the lengths A and B, the person information detection unit 24 determines whether or not the point fp detected from the second image is to be associated with the point fp detected from the first image. This determination will be described with reference to FIG. 7. FIG. 7 is an example of a second image in which the room interior rm of FIG. 5 is captured by the second camera 102 in the modified example of the first embodiment. Different from the second image of the first embodiment, in the second image in the modified example of the first embodiment, the subject is perspective-projected.

As depicted in FIG. 7, the first camera 101 is displayed in the center of the upper section of the second image. The distances from both edges of the second image, in other words, from both edges of the projection plane captured by the second camera 102, to the point fp are taken as lengths A′ and B′. If the point fp displayed in the first image and the point fp displayed in the second image are the toes of the same person, the ratio between the lengths A′ and B′ matches the ratio between the lengths A and B (that is, A′:B′=A:B). Based on these ratios, the person information detection unit 24 determines whether or not the points fp displayed in the first image and the second image are the same person, and associates the points fp on the basis of the determination result.

In this way, the person information detection unit 24 in the modified example of the first embodiment can detect points fp indicating the toes of a person inv, determine whether or not the person inv displayed in the first image and the person inv displayed in the second image are the same person on the basis of the detected fp positions, and generate person information on the basis of the determination result. Consequently, in the modified example of the first embodiment, an effect that is the same as that of the first embodiment can be obtained.

### MODIFIED EXAMPLE 2 OF FIRST EMBODIMENT

Hereinafter, a modified example 2 of the first embodiment will be described. With regard to the configuration, FIGS. 1 and 3 are cited, and the same functional units are denoted by the same reference signs. The installation conditions for the cameras in the modified example of the first embodiment are the installation conditions (1b) and (1c) described hereinafter with the installation condition (1a) from the first embodiment being omitted. The content of the installation condition (1b) is the same as in the first embodiment, and therefore a detailed description thereof is omitted. The installation condition (1c) is that the casings of both cameras are displayed in the central region of any of the upper section, the lower section, the left section, or the right section of the projection plane of the other camera. The installation method for the cameras satisfying the installation conditions (1b) and (1c) is, for example, the same as the method in which a grid pattern is used in the first embodiment, and therefore a detailed description thereof is omitted. It should be noted that the installation method for the cameras satisfying the installation conditions (1b) and (1c) is not restricted to a method in which a grid pattern is used. For example, the user may perform installation as follows.

The user hangs string from the first camera and performs an adjustment such that the second camera 102 is displayed in a substantially central region of one side of the projection plane of the first camera 101. Thereafter, the user captures the first camera 101 from the second camera 102 and performs an adjustment such that the string on the projection plane is displayed parallel to one side of the projection plane of the second camera 102 and the first camera 101 is displayed in a substantially central region of one side of the second camera 102. As a result of these adjustments, the first camera 101 and the second camera 102 are installed satisfying the installation conditions (1b) and (1c).

As a result, the position detection device 2 in the modified example 2 of the first embodiment can detect the three-dimensional position coordinates of a person that is approximately parallel-projected, from the first image and the second image, which are two-dimensional images. Furthermore, the position detection device 2 generates tracking information indicating the way in which the person has moved, and generates action information indicating what kind of action has been performed by the person, on the basis of the person information and the tracking information.

On the basis of the action information, the position detection device 2 is able to comprehend the action of a person inside the room, and, in addition, is able to cause a prescribed device to execute an operation corresponding to the action information. Furthermore, these effects can be obtained by performing installation such that the installation conditions (1b) and (1c) are satisfied, and it is therefore possible for the first camera 101 and the second camera 102 to be installed in a simple manner even by a person who does not possess special skills.

### Second Embodiment

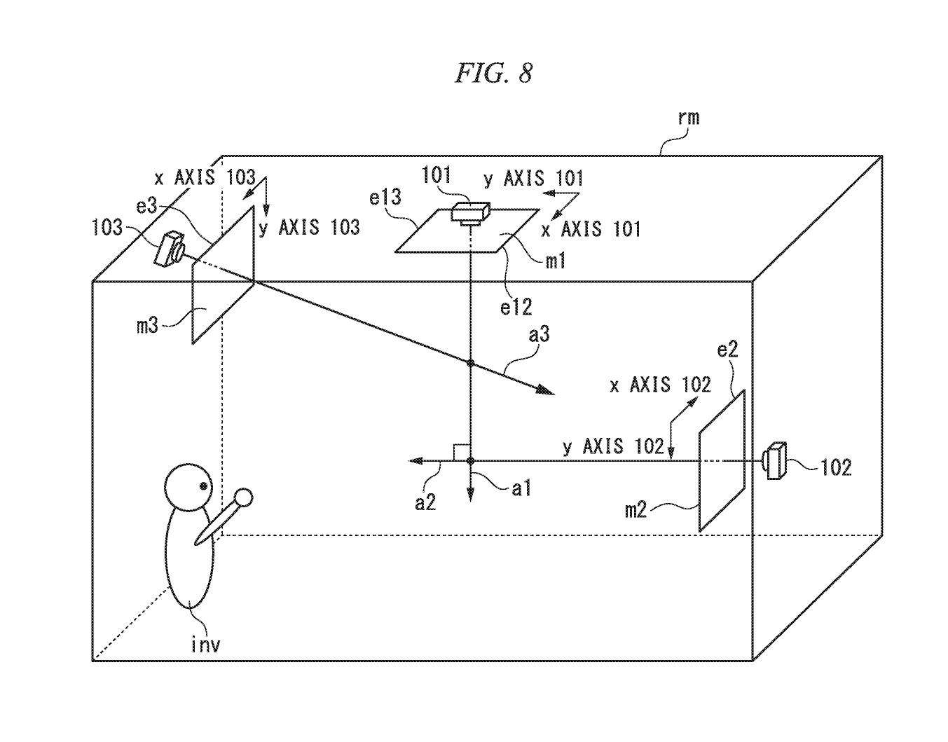

Hereinafter, a second embodiment will be described. FIG. 8 is an external view depicting a usage situation of the position detection device 2 in the second embodiment. With regard to the configuration, FIGS. 1 and 3 are cited, and the same functional units are denoted by the same reference signs. The position detection device 2 in the second embodiment is connected with the first camera 101, the second camera 102, and a third camera 103, and detects a person inv who has entered the room interior rm and detects three-dimensional position coordinates of the person inv on the basis of images captured from the first camera 101, the second camera 102, and the third camera 103.

The third camera 103, for example, is a camera provided with an imaging element that converts concentrated light into an electrical signal, such as a CCD element or a CMOS element. The first camera 101 is installed on the ceiling in the room interior rm, and the second camera 102 is installed on a wall surface in the room interior rm, for example. The third camera 103 is installed in the upper section of a wall surface positioned on the opposite surface to the wall surface on which the second camera 102 is installed. As depicted in FIG. 8, the optical axis a1 and the optical axis a2 intersect, and the optical axis a1 and an optical axis a3 intersect. Consequently, the third camera 103 performs imaging from the upper section of the wall surface on which the third camera 103 is installed, so as to look down on the lower section of the wall surface on which the second camera 102 is installed.

In the present embodiment, the optical axis a1 and the optical axis a2 are orthogonal in order to simplify the description; however, it should be noted that the present invention is not restricted thereto. Furthermore, the second camera 102 and the third camera 103 are facing each other and therefore complement each other with respect to regions in which it is difficult for them to be captured (for example, occlusion regions). Furthermore, although omitted from FIG. 8 as the drawing would become complex, the first camera 101, the second camera 102, and the third camera 103 are connected to the position detection device 2 by an HDMI (registered trademark) cable or the like. The position detection device 2, for example, may be installed in the room interior or may be installed in another room. In the present embodiment, the position detection device 2 is installed in another room. A projection plane m3 is the projection plane of the third camera 103, e13 is the side of the projection plane m1 that is the closest to the projection plane m3, and e12 is the side of the projection plane m1 that is the closest to the projection plane m2. Consequently, the first camera 101 and the second camera 102 satisfy the installation conditions (1a) and (1b), and, in addition, the first camera 101 and the third camera 103 also satisfy the installation conditions (1a) and (1b).

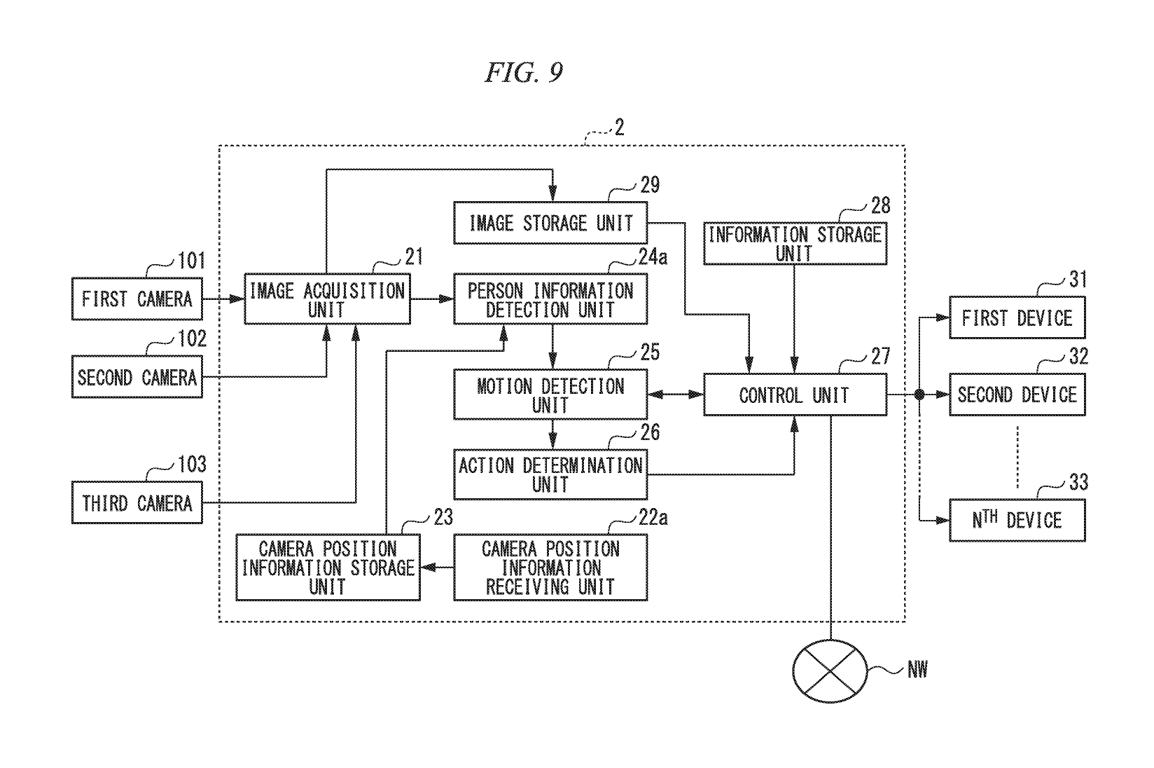

FIG. 9 is an example of schematic block diagram depicting a configuration of the position detection device 2 in the second embodiment. The position detection device 2, for example, includes the image acquisition unit 21, a camera position information receiving unit 22a, the camera position information storage unit 23, a person information detection unit 24a, a motion detection unit 25a, the action determination unit 26, the control unit 27, and the information storage unit 28. Furthermore, the position detection device 2 is communicably connected to devices 1 to n by a local area network (LAN) or the like. In the same drawing, the same reference signs (101 to 103, 21, 23, 25 to 29, and 31 to 33) are appended to portions corresponding to each unit of FIGS. 3 and 8, and descriptions thereof are omitted.

The camera position information receiving unit 22a receives camera position information due to an input operation from the user, and causes the received camera position information to be stored in the camera position information storage unit 23. The camera position information of the second embodiment is information obtained by associating: information obtained by associating a camera ID that identifies a camera connected to the position detection device 2 and information that indicates the distance from the camera indicated by the camera ID to a point at which imaging is desired to be performed; and information that indicates the angle formed between the optical axis of the camera and the floor surface.

The person information detection unit 24a acquires a first image, a second image, and a third image associated with a camera ID and an imaging time from the image acquisition unit 21. Thereafter, the person information detection unit 24a acquires camera position information from a camera position information storage unit 23a. The person information detection unit 24a, for example, detects a region indicating the face of a person from each of the acquired first image, second image, and third image of each imaging time. Here, the person information detection unit 24a determines whether or not a face region has been able to be detected from the first image. In the case where a face region has not been able to be detected from the first image, information indicating that a person has not been detected is generated as person information. In the case where a face region has been detected from the first image, if a face region has been detected from either of the second image or the third image, the person information detection unit 24a detects three-dimensional position coordinates and generates person information. Also in the case where a face region has been detected from the first image, if a face region has been detected from neither of the second image or the third image, the person information detection unit 24a generates information indicating that a person has not been detected as person information.

It should be noted that, in the case where face association processing is performed from the first image and the third image, a z coordinate of three-dimensional position coordinates is calculated on the basis of the angle formed between the optical axis a3 of the third camera 103 and the floor surface included in the camera position information and a trigonometric function or the like. When the three-dimensional position coordinates are detected, the person information detection unit 24a outputs the three-dimensional position coordinates, a person ID identifying the three-dimensional position coordinates, and information indicating the face of the person corresponding to the person ID, as person information to the motion detection unit 25. Furthermore, the person information detection unit 24a outputs the first image corresponding to the person information to the motion detection unit 25.

In this way, the position detection device 2 in the second embodiment can detect three-dimensional position coordinates from the first image, the second image, and the third image, which are two-dimensional images, due to the first camera 101, the second camera 102, and the third camera 103 being installed such that the installation conditions (1a) and (1b) are satisfied, and an effect that is the same as that of the first embodiment can be obtained. Furthermore, it is sufficient as long as the position detection device 2 in the second embodiment is able to detect the face region of a person from either the second camera 102 or the third camera 103 when detecting the z coordinate of the three-dimensional position coordinates, and therefore the possibility of the person no longer being detected due to an occlusion region is lower than with the position detection device 2 of the first embodiment.

In the case where a face region has not been detected from the first image, the person information detection unit 24a in the second embodiment determines that a person has not been detected; however, it should be noted that the present invention is not restricted thereto. For example, in the case where a face region has not been detected from the first image, the person information detection unit 24a may calculate the x coordinate and the y coordinate of the three-dimensional position coordinates detected from the first image, on the basis of the third image, camera position information, and a trigonometric function.

### Third Embodiment

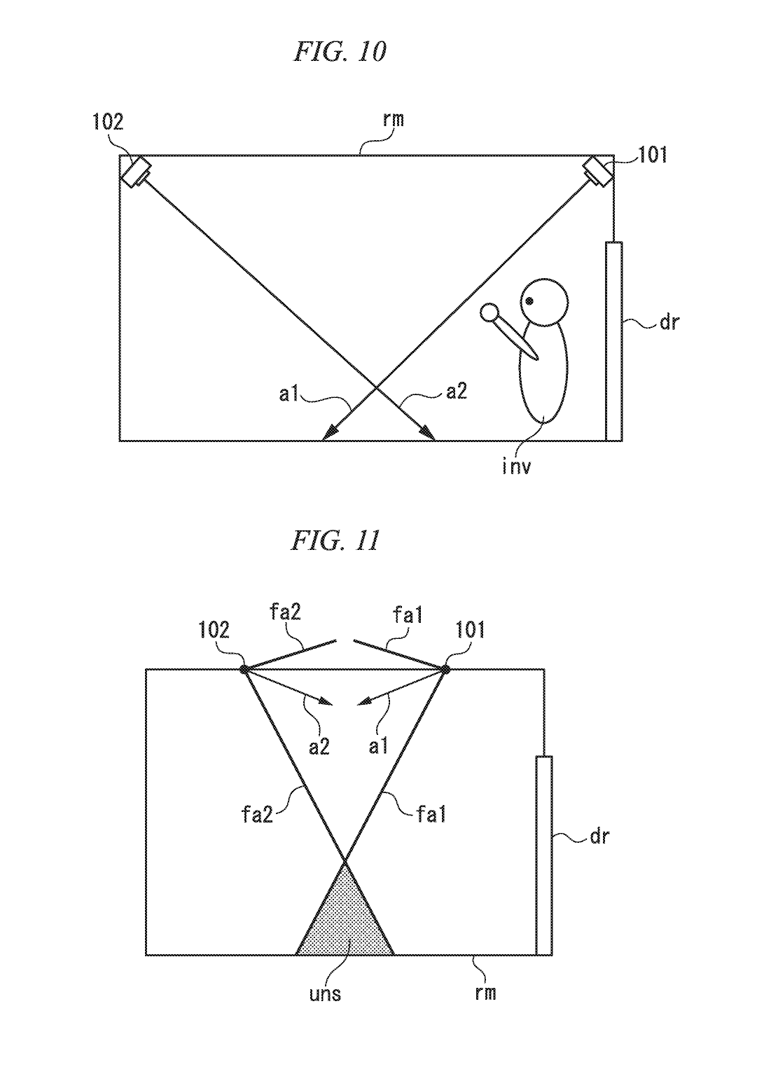

Hereinafter, a third embodiment will be described. FIG. 10 is an external view depicting a usage situation of the first camera 101 and the second camera 102 connected to the position detection device 2 in the third embodiment. With regard to the configuration, FIG. 1 is cited, and the same functional units are denoted by the same reference signs. The position detection device 2 in the third embodiment is connected with the first camera 101 and the second camera 102, and detects a person inv who has entered the room interior rm and detects three-dimensional position coordinates of the person inv on the basis of images captured from the first camera 101 and the second camera 102. Furthermore, the angle formed between optical axes a102 and a2 of the first camera 101 and the second camera 102, respectively, in the third embodiment and the floor surface is an angle between 0 and 90 degrees.

Specifically, the first camera 101 is installed so as to oppose the second camera 102, and is installed so as to look down on the lower section side of the wall surface on which the second camera 102 is installed from the upper section side of the wall surface on which the first camera 101 is installed. The second camera 102 is installed so as to look down on the lower section side of the wall surface on which the first camera 101 is installed from the upper section side of the wall surface on which the second camera 102 is installed. By performing installation in this way, the entire body of a person who has entered into the room can be captured regardless of where the person is in the room, and it is therefore possible to prevent it being determined that a person is not present due to a face region not being detected by the first camera 101 as in the first and second embodiments. However, in this kind of situation, due to the distance between the first camera 101 and the second camera 102 and the width of the angle of view of each camera, there are cases where there is a region that is not captured (hereinafter, referred to as a non-capturable region).

FIG. 11 is an example of an image diagram of a room interior in which the first camera 101 and the second camera 102 are installed, for describing a non-capturable region. Thick lines fa1 are lines indicating the range of the angle of view of the first camera 101. Thick lines fa2 are lines indicating the range of the angle of view of the second camera 102. In the case of FIG. 11(a), the lines fa1 indicating the angle of view of the first camera 101 and the lines fa2 indicating the angle of view of the second camera 102 intersect within the room interior, and therefore a non-capturable region uns is produced.

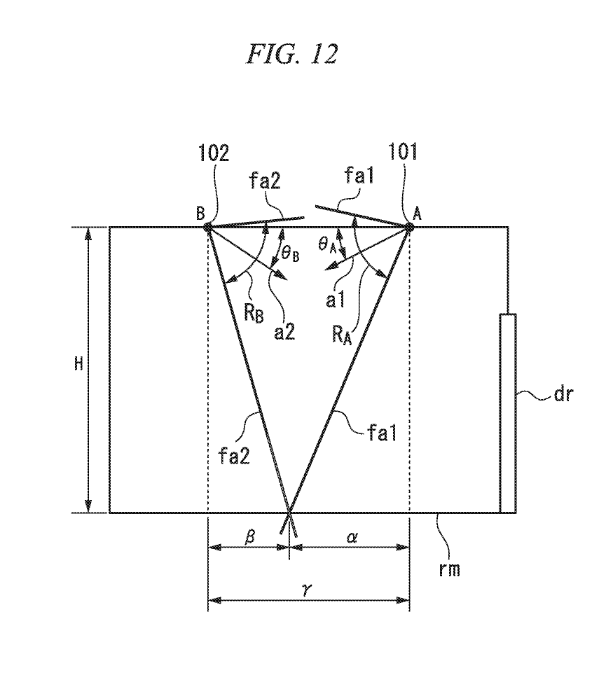

FIG. 12 is an example of an image diagram for describing a condition with which a non-capturable region uns is not produced. R_{A} is the angle of view of the first camera 101, and R_{B} is the angle of view of the second camera 102. Furthermore, the angle formed between the optical axis a101 of the first camera 101 and the ceiling (or, a plane that is level with the floor surface and passes through the center of the first camera 101) is indicated by θ_{A}, and the angle formed between the optical axis a2 of the second camera 102 and the ceiling (or, a plane that is level with the floor surface and passes through the center of the second camera 102) is indicated by θ_{B}. The height from the floor surface to a location where the first camera 101 or the second camera 102 is installed is taken as H. The distance in a direction horizontal with respect to the floor surface from a point where a line fa1 indicating an angle of view and a line fa2 indicating an angle of view intersect to the first camera 101 is taken as α, and the distance in a direction horizontal with respect to the floor surface from the same intersection point to the second camera 102 is taken as β. The horizontal-direction distance between the first camera 101 and the second camera 102 is indicated by γ.

In the case where a non-capturable region uns is produced, a person who has entered into the non-capturable region uns is not captured, and therefore the position detection device 2 determines that there is no person who has entered the room interior rm. In FIG. 12, the lines fa1 indicating the angle of view of the first camera 101 and the lines fa2 indicating the angle of view of the second camera 102 intersect outside of the room interior, and therefore a non-capturable region uns is not produced. That is, the condition for a non-capturable region uns to not be produced is that fa1 and fa2 intersect outside of the room. In order to realize this, in the third embodiment, it is necessary for the installation of the first camera 101 and the second camera 102 to satisfy an additional installation condition (c). The installation condition (c) is that the following expression (6) is satisfied.

α+β≧γ (6)

Here, by using a trigonometric function, the angle of views R_{A} and R_{B}, and the angles θ_{A} and θ_{B}, it is possible for α and β to be expressed with the following expressions (7) and (8).

$$\begin{matrix}[ Math . 1 ] & \\ α = H {tan}^{- 1} [ \frac{π}{2} - {θ}_{A} - \frac{{R}_{A}}{2} ] & ( 7 ) \\ [ Math . 2 ] & \\ β = H {tan}^{- 1} [ \frac{π}{2} - {θ}_{B} - \frac{{R}_{B}}{2} ] & ( 8 )\end{matrix}$$

In this way, if the cameras are installed such that the installation conditions (a), (b), and (c) are satisfied, an effect that is the same as that of the first and second embodiments can be obtained regardless of the direction in which the person is facing and so forth. Furthermore, a program for realizing the functions of each unit making up the position detection device 2 in FIGS. 3 and 9 may be stored in a computer-readable recording medium, and the position detection device 2 may be implemented by causing the program recorded on this recording medium to be read by a computer system and executed. It should be noted that a “computer system” referred to here includes an operating system (OS) and hardware such as a peripheral device.

Furthermore, in the case where a WWW system is used, the “computer system” includes a homepage provision environment (or a display environment).

Furthermore, a “computer-readable recording medium” refers to a portable medium such as a flexible disk, a magneto-optical disk, a ROM, or a CD-ROM, and a storage device such as a hard disk provided within the computer system. In addition, a “computer-readable recording medium” also includes a medium that dynamically retains a program for a short period of time as in a communication line when a program is transmitted via a network such as the Internet or a communication line such as a telephone line, and a medium that retains a program for a fixed time as in a volatile memory within a computer system constituting a server or a client of the aforementioned case. Furthermore, the aforementioned program may be a program that realizes some of the previously mentioned functions, and, in addition, may be a program that can realize the previously mentioned functions in combination with a program already recorded in the computer system.

Embodiments of this invention have been described in detail hereinabove with reference to the drawings; however, the specific configuration is not restricted to these embodiments, and design changes or the like of a scope that does not deviate from the gist of this invention are also included.

(1) An aspect of the present invention is a position detection device, provided with: an associating unit that uses a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, as a basis for associating a subject included in the first image and a subject included in the second image as the same subject; and a detection unit that detects three-dimensional coordinates of the associated subjects.

(2) Furthermore, another aspect of the present invention is the position detection device described in (1), in which the first camera is installed such that a side of a projection plane of the first camera that is closest to a projection plane of the second camera is substantially parallel with a side of the projection plane of the second camera that is closest to the projection plane of the first camera, and the second camera is installed such that the side of the projection plane of the second camera that is closest to the projection plane of the first camera is substantially parallel with the side of the projection plane of the first camera that is closest to the projection plane of the second camera.

(3) Furthermore, another aspect of the present invention is the position detection device described in (1) or (2), in which the associating unit associates subjects having a prescribed characteristic shape.

(4) Furthermore, another aspect of the present invention is the position detection device described in any one of (1) to (3), in which the associating unit detects first coordinates on the basis of a position in the first image of the subject included in the first image, detects second coordinates on the basis of a position in the second image of the subject included in the second image, and associates the subject detected from the first image and the subject detected from the second image, as the same subject on the basis of the first coordinates and the second coordinates, and the detection unit detects three-dimensional coordinates of the same subject on the basis of the first coordinates and the second coordinates.

(5) Furthermore, another aspect of the present invention is the position detection device described in (4), in which the first coordinates are coordinates of a direction orthogonal to the substantially central axis of an image in which the first camera is captured by the second camera, the second coordinates are coordinates of a direction orthogonal to the substantially central axis of an image in which the second camera is captured by the first camera, and the associating unit associates the subject included in the first image and the subject included in the second image as the same subject when the first coordinates and the second coordinates match.

(6) Furthermore, another aspect of the present invention is the position detection device described in (3), or (4) or (5) in which (3) is cited, in which the prescribed characteristic shape is a face of a person or toes of a person.

(7) Furthermore, another aspect of the present invention is a camera installation method, in which a first camera is installed such that a second camera is displayed on a substantially central axis in a vertical direction or a horizontal direction in a first image captured by the first camera, and the second camera is installed such that the first camera is displayed on a substantially central axis in the vertical direction or the horizontal direction in the first image captured by the second camera.

(8) Furthermore, another aspect of the present invention is a position detection method, in which a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, are used as a basis for associating a subject included in the first image and a subject included in the second image as the same subject, and three-dimensional coordinates of the associated subject are detected.

(9) Furthermore, another aspect of the present invention is a position detection program, in which a computer is made to use a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, as a basis for associating a subject included in the first image and a subject included in the second image as the same subject, and to detect three-dimensional coordinates of the associated subject.

### INDUSTRIAL APPLICABILITY

The present invention is preferably used when the position of a subject within an imaging region is to be detected, but is not restricted thereto.

### DESCRIPTION OF REFERENCE NUMERALS

1 Device

2 Position detection device

21 Image acquisition unit

22, 22a Camera position information receiving unit

23 Camera position information storage unit

24, 24a Person information detection unit

25 Motion detection unit

26 Action determination unit

27 Control unit

28 Information storage unit

29 Image storage unit

31 First device

3n N^{th} device

101 First camera

102 Second camera

103 Third camera

1. A position detection device, comprising:
an associating unit that uses a first image, which is captured by a first camera and includes a second camera displayed on a substantially central axis in a vertical direction or a horizontal direction, and a second image, which is captured by the second camera and includes the first camera displayed on the substantially central axis in the vertical direction or the horizontal direction, as a basis for associating a subject included in the first image and a subject included in the second image as the same subject; and
a detection unit that detects three-dimensional coordinates of the associated subjects.

2. The position detection device according to claim 1, wherein
the first camera is installed such that a side of a projection plane of the first camera that is closest to a projection plane of the second camera is substantially parallel with a side of the projection plane of the second camera that is closest to the projection plane of the first camera,
and the second camera is installed such that the side of the projection plane of the second camera that is closest to the projection plane of the first camera is substantially parallel with the side of the projection plane of the first camera that is closest to the projection plane of the second camera.

3. The position detection device according to claim 1, wherein
the associating unit associates subjects having a prescribed characteristic shape.

4. The position detection device according to claim 1, wherein
the associating unit detects first coordinates on the basis of a position in the first image of the subject included in the first image, detects second coordinates on the basis of a position in the second image of the subject included in the second image, and associates the subject detected from the first image and the subject detected from the second image, as the same subject on the basis of the first coordinates and the second coordinates,
and the detection unit detects three-dimensional coordinates of the same subject on the basis of the first coordinates and the second coordinates.

5. The position detection device according to claim 4, wherein
the first coordinates are coordinates of a direction orthogonal to the substantially central axis of an image in which the first camera is captured by the second camera,
the second coordinates are coordinates of a direction orthogonal to the substantially central axis of an image in which the second camera is captured by the first camera,
and the associating unit associates the subject included in the first image and the subject included in the second image as the same subject when the first coordinates and the second coordinates match.

6. The position detection device according to claim 2, wherein
the associating unit associates subjects having a prescribed characteristic shape.

7. The position detection device according to claim 2, wherein
the associating unit detects first coordinates on the basis of a position in the first image of the subject included in the first image, detects second coordinates on the basis of a position in the second image of the subject included in the second image, and associates the subject detected from the first image and the subject detected from the second image, as the same subject on the basis of the first coordinates and the second coordinates,
and the detection unit detects three-dimensional coordinates of the same subject on the basis of the first coordinates and the second coordinates.

8. The position detection device according to claim 3, wherein
the associating unit detects first coordinates on the basis of a position in the first image of the subject included in the first image, detects second coordinates on the basis of a position in the second image of the subject included in the second image, and associates the subject detected from the first image and the subject detected from the second image, as the same subject on the basis of the first coordinates and the second coordinates,
and the detection unit detects three-dimensional coordinates of the same subject on the basis of the first coordinates and the second coordinates.
